(19) United States
(12) Patent Application Publication
(10) Pub. No.: US 2009/0301345 A1
(43) Pub. Date: Dec. 10, 2009

(54) PYROGENICALLY PRODUCED SILICON DIOXIDE DOPED BY MEANS OF AN AEROSOL

(76) Inventors: Helmut Mangold, Rodenbach (DE); Mitsuru Ochiai, Hasuda City (JP); Holger Glaum, Maintal (DE); Astrid Muller, Mombris (DE)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/471,974

(22) Filed: May 26, 2009

Related U.S. Application Data
(62) Division of application No. 10/404,663, filed on Apr. 2, 2003, now abandoned.
Application No. 10/404,663 is a continuation of application No. 09/418,360, filed on Oct. 14, 1999, now abandoned.

(30) Foreign Application Priority Data
Oct. 14, 1998 (DE) 198 47 161.0

(51) Int. Cl. C09D 11/02; C01B 33/26; C09D 1/00

(52) U.S. Cl. 106/31.13; 423/327.1; 106/483

(57) ABSTRACT

Pyrogenically produced silicon dioxide doped with aluminum oxide by means of an aerosol is produced by introducing an aqueous aerosol of an aluminum salt into the flame of a pyrogenic silica producing flame hydrolysis method or a flame oxidation method. The silicon dioxide doped with Al₂O₃ by means of an aerosol may inter alia be used in the production of inkjet paper or inkjet films.

### CROSS-REFERENCE TO RELATED APPLICATIONS

This is a continuation of U.S. patent application Ser. No. 09/418,360, filed Oct. 14, 1999, which in turn claims priority to German Application DE 198 47 161.0, filed Oct. 14, 1998, both disclosures are incorporated in their entirety herein by reference.

### FIELD OF THE INVENTION

This invention relates to pyrogenically produced silicon dioxide doped with aluminum oxide by means of an aerosol, which silicon dioxide is very readily dispersible in polar media, and to a process for the production thereof, and to the use thereof in papermaking, in particular in inkjet paper and inkjet film. The invention furthermore relates to the use thereof for the production of low, viscosity dispersions or for the production of highly-filled dispersions.

### BACKGROUND OF THE INVENTION

Extremely readily dispersible fillers, which absorb ink well and retain brilliance of colour, are required for use in the paper industry for example, for inkjet paper and inkjet film.

It is known to dope pyrogenically produced silica in a flame in one step, as described in DE 196 50 500 A1 and EP-A 0 850 876. This process comprises a combination of high temperature flame hydrolysis with pyrolysis. This doping process should be distinguished from the prior, so-called “co-fumed process”, in which the gaseous starting products (for example SiCl₄ gas and AlCl₃ gas) are premixed and jointly combusted in a flame reactor, wherein pyrogenically produced mixed oxides are obtained.

The products produced using the two different processes exhibit distinctly different application properties.

In the doping process used according to the invention, an aerosol containing a salt of the compound to be doped, is introduced into a flame, wherein an oxide produced by flame hydrolysis.

### SUMMARY OF THE INVENTION

It has now been found that when aluminum compounds dissolved in water are used as the starting product for the aerosol to be introduced into the flame, the pyrogenically produced silica doped with aluminum oxide obtained is extremely readily dispersible in polar media, such as water, and is highly suitable for use in inkjet paper and inkjet film.

### BRIEF DESCRIPTION OF THE DRAWINGS

FIG. 1 is a schematic representation of the doping apparatus.

FIG. 2 is an electron micrograph of pyrogenically produced silica doped with aluminum oxide, of the present invention.

### DETAILED DESCRIPTION OF THE INVENTION

The present invention provides a pyrogenically produced silica doped with aluminum oxide by means of an aerosol, wherein the silica component is produced pyrogenically using a flame oxidation method or preferably, flame hydrolysis method. The silica component is doped with a doping component of 1×10⁻⁴ wt. % to 20 wt. %, and the doping quantity is preferably in the range from 1 ppm to 10000 ppm. The doping component is an aluminum salt or mixture thereof, a suspension of an aluminum compound, metallic aluminum, or mixtures thereof. The BET surface area of the doped oxide is between 5 m²/g and 600 m²/g, and is preferably in the range of between 40 m²/g and 100 m²/g.

The silica according to the invention may have a DBP value of below 100 g/100 g.

The present invention also provides a process for the production of the pyrogenically produced silicas doped with aluminum oxide by means of an aerosol. In this process, an aerosol containing an aluminum doping component, is introduced into a flame, used for the pyrogenic production of silica by the flame oxidation method or, preferably, by the flame hydrolysis method. The aerosol is homogeneously mixed with the flame oxidation or flame hydrolysis gas mixture before the reaction, then the aerosol/gas mixture is allowed to react in the flame and the resultant pyrogenically produced silicas doped with aluminum oxide are separated from the gas stream in a known manner. The aerosol is produced using an aqueous solution which contains aluminum salt or mixtures thereof, aluminum metal in dissolved or suspended form, or mixtures thereof. The aerosol is produced by atomization by means of a two-fluid nozzle or by another aerosol production method, preferably by an aerosol generator using ultrasound atomization.

Salts which may be used are: AlCl₃, Al₂(SO₄)₃, Al(NO₃)₃.

The flame hydrolysis processes for the production of pyrogenic oxides and thus also for the production of silicon dioxide (silica) are known from Ullmanns Enzyklopädie der technischen Chemie, 4th edition, volume 21, page 464, which is herein incorporated by reference.

The present invention also provides for the use of the pyrogenically produced silica doped by means of an aerosol as a filler, in particular in the paper industry for the production of inkjet paper and inkjet film or other inkjet materials, such as for example canvas, plastic films, etc. The pyrogenically produced silica doped by means of an aerosol may also be used as a support material, as a catalytically active substance, as a starting material for the production of dispersions, as a polishing agent (CMP applications), as a ceramic base material, in the electronics industry, as a filler for polymers, as a starting material for the production of glass or glass coatings or glass fibers, as a release auxiliary even at elevated temperatures, in the cosmetics industry, as an absorbent, as an additive in the silicone and rubber industry, for adjusting the Theological properties of liquid systems; for heat stabilization, as a thermal insulating material, as a flow auxiliary, as a filler in the dental industry, as an auxiliary in the pharmaceuticals industry, in the lacquer industry, in PET film applications, in fluorescent tubes, as a starting material for the production of filter ceramics or filters.

The present invention also provides for blends of 0.01% to 100% of the silicas according to the invention with other pyrogenically produced or precipitated silicas, bentonites or fillers, or mixtures of these fillers conventional in the paper industry.

The silica according to the invention, which is, for example, obtained as the product when aluminum chloride salts dissolved in water are used to produce the aerosol to be introduced may very readily be dispersed in polar media, such as for example water. The silica is accordingly suitable for use in the production of inkjet paper and inkjet films. It is possible using the doped, pyrogenically produced silicon dioxide dispersed in water to apply transparent or glossy coatings onto inkjet media, such as paper or film.

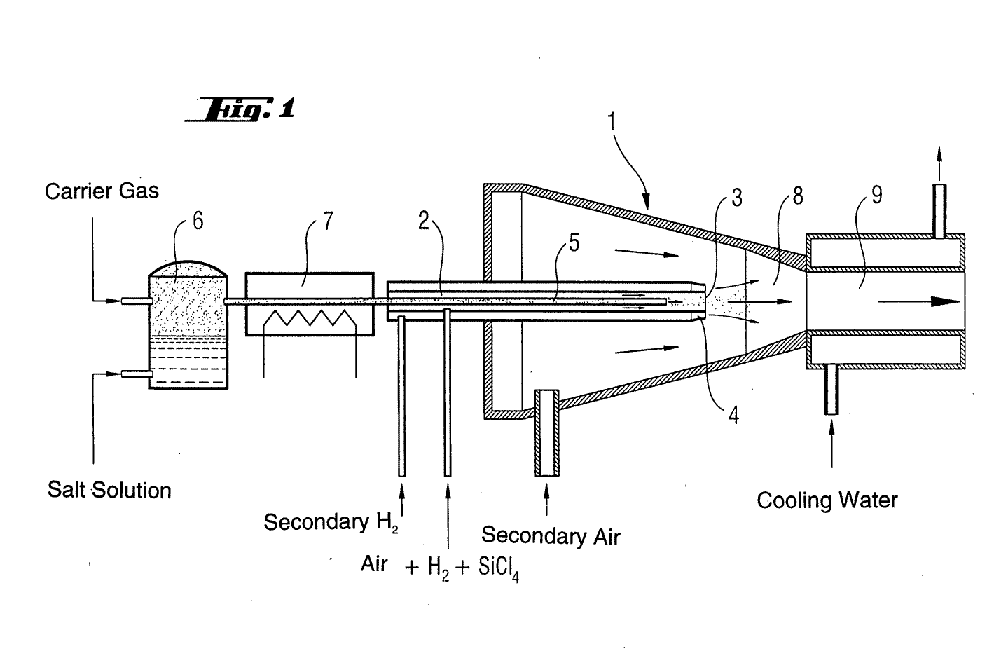

The silicon dioxide according to the invention and the process for the production thereof, as well as the use thereof, are illustrated and described in greater detail by means of FIG. 1 and the following Examples.

FIG. 1 is a schematic representation of the doping apparatus. The central component of the apparatus is a burner of a known design for the production of pyrogenic oxides.

The burner 1 consists of central tube 2, which opens into nozzle 3, from which the main gas stream flows into the combustion chamber 8 and combusts therein. The nozzle 3 is surrounded by the annular nozzle 4, from which annular or secondary hydrogen flows.

The axial tube 5 is located in the central tube 2, which axial tube ends a few centimeters before the nozzle 3 of the central tube 2. The aerosol is introduced into the axial tube 5.

The aerosol, which consists of an aqueous aluminum chloride solution, is produced in an aerosol generator 6 which may be an ultrasound atomizer.

The aluminum chloride/water aerosol produced in the aerosol generator 6 is passed by means of a gentle carrier gas stream through the heating zone 7, in which the entrained water vaporizes, wherein small salt crystals remain in the gas phase in finely divided form.

### Example 1

### Production of a Pyrogenically Produced Silica Doped with Aluminum Oxide by Means of an Aerosol and Having a Low Bet Surface Area

5.25 kg/h of SiCl₄ are vaporized at about 130° C. and transferred into the central tube 2 of the burner 1. 3.47 Nm³/h of (primary) hydrogen and 3.76 Nm³/h of air are additionally introduced into the central tube 2. 0.95 Nm³/h of oxygen are additionally added to this mixture.

The gas mixture flows from the nozzle 3 of the burner 1 and burns in the combustion chamber 8 and the water-cooled flame tube 9 connected thereto.

0.5 Nm³/h of (jacket or secondary) hydrogen as well as 0.3 Nm³/h of nitrogen are introduced into the annular nozzle 4.

20 Nm³/h of (secondary) air are also additionally introduced into the combustion chamber 8.

The secondary gas stream flows from the axial tube 5 into the central tube 2.

The secondary gas stream consists of the aerosol, which is produced by ultrasound atomization of AlCl₃ solution in the aerosol generator 6. The aerosol generator 6 here atomizes 460 g/h of 2.29% aqueous aluminum trichloride solution. The aluminum chloride aerosol is passed through the heated line with the assistance of 0.5 Nm³/h of air as carrier gas, wherein the aqueous aerosol is converted into a gas and salt crystal aerosol at temperatures of about 180° C.

At the mouth of the burner, the temperature of the gas mixture (SiCl₄/air/hydrogen, water aerosol) is 156° C.

The reaction gases and the pyrogenic silica doped with aluminum oxide by means of an aerosol are drawn through the cooling system by application of reduced pressure. The particle/gas stream is consequently cooled to about 100° C. to 160° C. The solids are separated from the exit gas stream in a cyclone.

The pyrogenically produced silica doped with aluminum oxide by means of an aerosol is obtained as a white, finely divided powder.

In a further step, any residues of hydrochloric acid adhering to the silica are removed from the silica at elevated temperature by treatment with air containing steam.

The BET surface area of the pyrogenic silica doped with aluminum oxide is 55 m²/g.

Table 1 summarizes the production conditions. Table 2 states further analytical data for the silica according to the invention.

### Example 2

### Production of a Pyrogenically Produced Silica Doped with Aluminum Oxide by Means of an Aerosol and Having an Elevated Bet Surface Area

4.44 kg/h of SiCl₄ are vaporized at about 130° C. and transferred into the central tube 2 of the burner 1 of a known design. 3.15 Nm³/h of (primary) hydrogen and 8.2 Nm³/h of air are additionally introduced into the central tube 2.

The gas mixture flows from the nozzle 3 of the burner 1 and burns in the combustion chamber 8 and the water-cooled flame tube 9 connected thereto.

0.5 Nm³/h of secondary hydrogen and 0.3 Nm³/h of nitrogen are introduced into the annular nozzle 4.

12 Nm³/h of secondary air is also additionally introduced into the combustion chamber 8.

The secondary gas stream flows from the axial tube 5 into the central tube 2.

The secondary gas stream consists of the aerosol, which is produced by ultrasound atomization of AlCl₃ solution in the separate atomizing unit 6. The aerosol generator 6 here atomizes 450 g/h of 2.29% aqueous aluminum trichloride solution. The aluminum chloride aerosols passed through the heated line with the assistance of 0.5 Nm³/h of air as carrier gas, wherein the aqueous aerosol is converted into a gas and salt crystal aerosol at temperatures of about 180° C.

At the mouth of the burner, the temperature of the gas mixture (SiCl₄/air/hydrogen, water aerosol) is 180° C.

The reaction gases and the pyrogenically produced silica doped with aluminum oxide by means of an aerosol are drawn through a cooling system by application of reduced pressure. The particle/gas stream is consequently cooled to about 100° C. to 160° C. The solids are separated from the exit gas stream in a cyclone.

Pyrogenically produced silica doped with aluminum oxide by means of an aerosol is obtained as a white, finely divided powder. In a further step, any residues of hydrochloric acid adhering to the silica are removed at elevated temperature by treatment with air containing steam.

The BET surface area of the pyrogenic silica doped with aluminum oxide by means of an aerosol is 203 m²/g.

Table 1 shows the production conditions. Table 2 shows additional analytical data for the silica according to the invention.

TABLE 1
Experimental conditions during the production of pyrogenic silica doped with aluminum oxide

| | | Primary | O₂ | Sec. | H₂ | H₂ | N₂ | Gas | | Aerosol | Air | |
|---|---|---|---|---|---|---|---|---|---|---|---|---|
| | SiCl₄ | air | centre | air | centre | jacket | jacket | temp. | Salt | quantity | aeros. | BET |
| No. | kg/h | Nm³/h | Nm³/h | Nm³/h | Nm³/h | Nm³/h | Nm³/h | ° C. | solution | kg/h | Nm³/h | m²/g |
| 1 | 5.25 | 3.76 | 0.95 | 20 | 3.47 | 0.5 | 0.3 | 156 | 2.29% | 0.46 | 0.5 | 55 |
| | | | | | | | | | aqueous | | | |
| | | | | | | | | | AlCl₃ | | | |
| 2 | 4.44 | 8.2 | 0 | 12 | 3.15 | 0.5 | 0.3 | 180 | 2.29% | 0.45 | 0.5 | 203 |
| | | | | | | | | | aqueous | | | |
| | | | | | | | | | AlCl₃ | | | |

Legend: Primary air = quantity of air in central tube; Sec. air = secondary air, H₂ center = hydrogen in central tube; Gas temp. = gas temperature at the nozzle of the central tube; Aerosol quantity = mass flow rate of the salt solution converted into aerosol form; Air aeros. = carrier gas (air) quantity of the aerosol

TABLE 2
Analytical data of the specimens obtained according to Examples 1 and 2

| | | | Tamped | DBP | Al₂O₃ | SiO₂ | Chloride |
|---|---|---|---|---|---|---|---|
| | BET | pH value | density | absorption | content | content | content |
| | m²/g | 4% susp. | g/l | g/100 g | wt. % | wt. % | ppm |
| Example No. 1 | 55 | 4.39 | 94 | 81 | 0.187 | 99.79 | 89 |
| Example No. 2 | 203 | 4.15 | 24 | 326 | 0.27 | 99.67 | |

By way of comparison

| | | | | | | | |
|---|---|---|---|---|---|---|---|
| Aerosil OX 50 | 50 | 3.8 to 4.8 | 130 | approx. 160 | <0.08 | >99.8 | <250 |

Legend: pH 4% susp. = pH value of the 4% aqueous suspension

### Electron Micrograph:

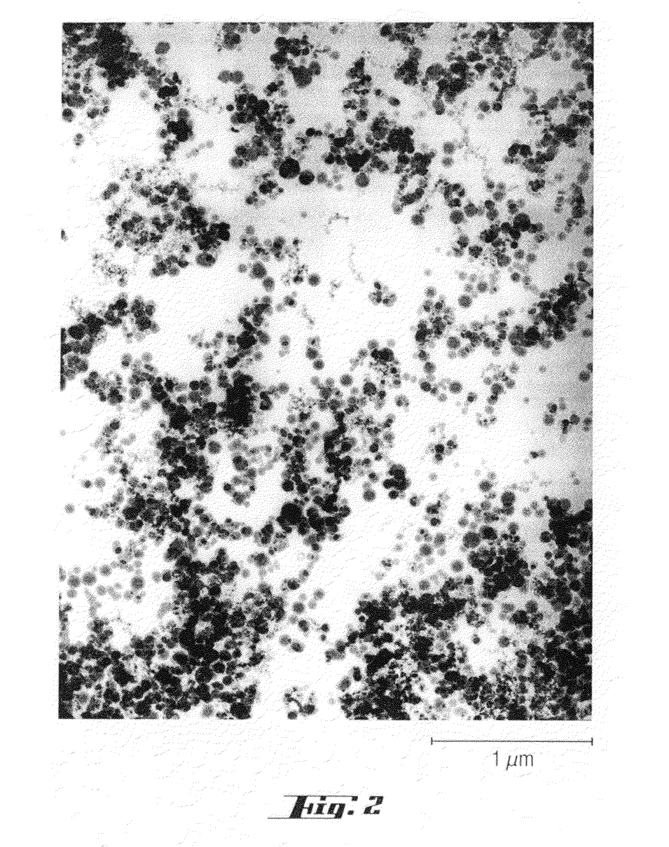

FIG. 2 shows an electron micrograph of the pyrogenic silica doped with aluminum oxide by means of an aerosol according to Example 1.

It is striking that there are numerous individual spherical primary particles, which have not intergrown.

The difference between the pyrogenic silicas doped with aluminum oxide by means of an aerosol according to the invention and pyrogenic silicas produced using a known method and having the same specific surface area is, in particular, revealed by the DBP absorption, which is a measure of the “structure” of the pyrogenic silica (i.e. of the degree of intergrowth).

The commercially available silica OX 50 produced using the pyrogenic high temperature flame hydrolysis process thus exhibits DBP absorption of about 160 (g/100 g) (at a BET surface area of 50 m²/g), while the pyrogenic silica doped with 0.187 wt. % of Al₂O₃ according to the invention exhibits DBP absorption of only 81 (g/100 g). The very low DBP absorption means that low viscosity dispersions may be produced from the pyrogenic silica doped with aluminum oxide according to the invention. By virtue of these properties, dispersions having an elevated filler content may readily be produced.

Moreover, particular note should be taken of the excellent dispersibility and incorporability of the silica according to the invention.

This is advantageous, especially for use as an absorbent filler in papermaking, particularly for use in inkjet paper and inkjet films.

Transparent and glossy coatings may also be produced from the dispersions of the silicas according to the invention.

Table 3 shows the difference in incorporation behavior and viscosity.

The following, commercially available pyrogenic oxides and mixed oxides are used by way of comparison (all products of Degussa, Frankfurt): AEROSIL 200 (pyrogenically produced silica), MOX 170 (pyrogenically produced aluminum/silicon mixed oxide), ALUMINUMOXID C (pyrogenically produced aluminum oxide).

TABLE 3

| | Aerosil | MOX | Alu | Example | Example |
|---|---|---|---|---|---|
| Name | A 200 | 170 | C | 1 | 2 |
| SiO₂ content [wt. %] | >99:8 | >98.3 | <0.1 | 99.79 | 99.67 |
| Al₂O₃ [wt. %] | <0.05 | 0.8 | >99.6 | 0.187 | 0.27 |
| BET [m²/g] | 200 | 170 | 100 | 55 | 203 |
| DBP absorption | 330 | 332 | 230 | 81 | 325 |
| [g/100 g] | | | | | |
| Incorporability | moderate to | moderate | moderate | very | moderate |
| | difficult | | | good | |
| Viscosity [mPas] | | | | | |
| at 5 rpm: | 4560 | 880 | 560 | 400 | 14480 |
| at 100 rpm: | 1200 | 420 | 330 | 210 | 2570 |
| BET [m²/g] | | | | | |
| before sintering: | 200 | 170 | | 55 | 203 |
| after 3 hours' | 17 | 43 | | 50 | 125 |
| sintering at 1150° C. | | | | | |
| Bulk density [g/l] | | | | | |
| before sintering | 40 | 40 | | 73 | 17 |
| after 3 hours' | 160 | 220 | | 80 | 26 |
| sintering at 1150° C. | | | | | |

Incorporability refers to the speed with which the powder may be stirred into a given liquid.

In comparison with the known pyrogenically produced mixed oxide MOX 170, which contains >98.3 wt. % of silicon dioxide and 0.8 wt. % of Al₂O₃ and is produced by flame hydrolysis of a mixture of AlCl₃ and SiCl₄, the pyrogenically produced silicon dioxide doped by means of an aerosol according to the invention, exhibits distinctly reduced sintering activity.

As is evident from Table 3, the known pyrogenically produced oxides, such as AEROSIL 200 (silicon dioxide) and MOX 170 (Al₂O₃/SiO₂ mixed oxide), sinter together with a distinct increase in bulk density, wherein the BET surface simultaneously falls sharply.

In contrast, the pyrogenically produced silicon dioxides doped by means of an aerosol according to the invention, exhibit only a slight change in bulk density after sintering: This means that the silicon dioxides according to the invention have a distinctly reduced sintering activity.

Viscosity was determined in a 15% aqueous dispersion relative to solids content. The solids content is composed of the following parts: 50 parts by weight of the pyrogenic silica, as well as, 30 parts by weight of MOWIOL 28-99 (polyvinyl alcohol, Cassella-Höchst) and 50 parts by weight of LUMITEN PPR 8450 (polyvinylpyrrolidone, BASF).

The 15% aqueous dispersion is stirred for 30 minutes at 3000 rpm in a high-speed stirrer, then allowed to stand for 24 hours, then briefly stirred by hand and measured at 23° C. using a Brookfield viscosimeter (model RVT), with spindle size being adapted to the particular viscosity.

### Evaluation of Printing Behaviour:

A commercially available film (Kimoto 105 g/m²) is coated with the 15% dispersion described above, after 10 days of storage, (with brief shaking) using a no. 4 coating knife and is printed with a Hewlett-Packard 550 C printer. Print quality is assessed visually. (Best mark=1, worst mark=6).

Tables 4 and 5 show the results for three-color printing and four-color printing.

TABLE 4
Three-color printing. (All Color) HP 550 C

| | Aerosil | MOX | Alu | Example | Example |
|---|---|---|---|---|---|
| Name | A 200 | 170 | C | 1 | 2 |
| Color Intensity | | | | | |
| M/G/C | 1 | 1 | 1 | 1 | 1 |
| black | 1 | 1 | 1 | 1 | 1.75 |
| Dot sharpness | | | | | |
| Black in color | 1.5 | 1.75 | 1.75 | 1.75 | 1.5 |
| Transitions | | | | | |
| Color in color | 1 | 1 | 1 | 1 | 1 |
| Dot sharpness | | | | | |
| Black print | 1 | 1 | 1 | 1 | 1.75 |
| Dot sharpness | | | | | |
| Black outlines | 1.5 | 1.5 | 1 | 1 | 1.5 |
| Continuous tone | | | | | |
| printing | | | | | |
| Color | 1 | 1 | 1.75 | 1.5 | 1 |
| intensity/Outlines | | | | | |
| Total evaluation | 8 | 8.25 | 8.5 | 8.25 | 8.5 |
| Average | 1.14 | 1.17 | 1.21 | 1.17 | 1.21 |
| evaluation | | | | | |

M/G/C: Magenta, green, cyan

TABLE 5
Four-color printing (Black and Color) HP 550 C

| | Aerosil | MOX | Alu | Example | Example |
|---|---|---|---|---|---|
| Name | A 200 | 170 | C | 1 | 2 |
| Color Intensity | | | | | |
| M/G/C | 1 | 1 | 1 | 1 | 1 |
| black | 1 | 1 | 1 | 1 | 1 |
| Dot sharpness | | | | | |
| Black in color | 3.5 | 3.5 | 1.5 | 3 | 3.5 |
| Transitions | | | | | |
| Color in color | 1 | 1 | 1 | 1 | 1 |
| Dot sharpness | | | | | |
| Black print | 1 | 1 | 1 | 1 | 1 |
| Dot sharpness | | | | | |
| Black outlines | 1.5 | 1.75 | 1.75 | 2 | 1.75 |
| Continuous tone | | | | | |
| printing | | | | | |
| Color | 1.5 | 1.5 | 1.5 | 1.5 | 1.5 |
| intensity/Outlines | | | | | |
| Total evaluation | 10.5 | 10.75 | 9.5 | 10.5 | 9.75 |
| Average | 1.5 | 1.5 | 1.4 | 1.5 | 1.4 |
| evaluation | | | | | |

In principle, blends of the silicas according to the invention with other pyrogenically produced or precipitated silicas, bentonites or fillers or mixtures of these fillers conventional in the paper industry are also possible.

1-20. (canceled)

21. A process for the production of the pyrogenically produced silica, doped with aluminum oxide by means of an aerosol, comprising:
introducing an aerosol containing an aluminum doping component into a flame of a flame oxidation method or flame hydrolysis method for the pyrogenic production of silica;
homogeneously mixing said aerosol with a flame oxidation or flame hydrolysis gas mixture within said flame;
reacting the aerosol/gas mixture in the flame to form pyrogenically produced silica doped with aluminum oxide; and
separating said pyrogenically produced silica doped with aluminum oxide from a product gas stream.

22. The process according to claim 21, further comprising:
producing the aerosol by atomization.

23. The process according to claim 22, comprising:
carrying out the atomization using a two-fluid nozzle.

24. A method for using a pyrogenically produced silica, doped with aluminum oxide by means of an aerosol, comprising:
treating a silica produced pyrogenically using a flame oxidation method as a flame hydrolysis method, with an aerosol containing an aluminum oxide doping component to produce the pyrogenically produced silica doped with aluminum oxide; and
incorporating the pyrogenically produced silica doped with aluminum oxide into inkjet paper, inkjet film or other inkjet material.
